(19) United States
(12) Patent Application Publication
(10) Pub. No.: US 2009/0269174 A1
(43) Pub. Date: Oct. 29, 2009

(54) RACK MOVER ASSEMBLY

(76) Inventor: Andrew Enyart, LaGrange, IN (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 12/425,782

(22) Filed: Apr. 17, 2009

Related U.S. Application Data
(60) Provisional application No. 61/047,670, filed on Apr. 24, 2008.

(51) Int. Cl. B65G 1/00; B65G 1/14

(52) U.S. Cl. 414/331.03; 414/331.14

(57) ABSTRACT

A rack mover, attachable to a rack, includes a wheeled jack for lifting the rack off the support surface and a jack-mounting assembly. The jack-mounting assembly includes a first member to which the jack is coupled and a second member including hooked projections extending a length through respective openings in the first member. The hooked projections are configured to engage the rack. A biasing member of the jack-mounting assembly biases the second member in a first direction relative to the first member such that the hooked projections extend a first length through the respective openings. A tightening assembly of the jack-mounting assembly is engaged with the second member and configured to move the second member relative to the first member in a direction substantially opposite the first direction to reduce the length of extension of the hooked projections through the respective openings to a second length less than the first length.

### CROSS-REFERENCE TO RELATED APPLICATIONS

This application claims priority to U.S. Provisional Patent Application No. 61/047,670, filed Apr. 24, 2008, the entire contents of which is hereby incorporated by reference.

### BACKGROUND

The present invention relates to apparatuses and methods for moving different types of fixtures and articles and, more particularly to apparatuses and methods for moving storage and display systems such as warehouse storage rack assemblies and store shelving assemblies.

Many types of product storage and display devices, such as shelves, gondolas, tables, racks, pallets, and other shelving assemblies, exist in today's marketplace for displaying and/or storing products and increasing product storage space. Hereinafter, the terms “rack” and “rack assembly” refer to any product supporting device, storage device or surface used to support, display or store products.

Such racks are difficult to move. They are typically manufactured with strong, heavy materials such as steel.

Rack assemblies in retail environments are often moved to accommodate ever-changing space requirements and marketing strategies. Moving these rack assemblies can be performed in a variety of conventional methods. However, limitations and problems exist with many such conventional methods, particularly when the racks are moved without the aid of any lifting equipment. For example, when manually picking-up the assembled racks or disassembling the rack assemblies and carrying the disassembled pieces individually, movers may injure themselves or damage the racks. The rack assembly is still heavy, awkward, and difficult to pick up, even after the merchandise is removed. Moreover, manually picking up assembled racks can take several people and be very time consuming. Disassembling rack assemblies prior to moving them reduces the potential for injuring movers; however, disassembling, transporting, and reassembling are a time-consuming processes.

Racks are typically assembled in long runs of interconnected components. Forty-foot runs (or more) are common. To move them with lift trucks (or other) requires some disassembly of the run into manageable sub-assemblies. This is a time-consuming process.

In light of the limitations and problems of the prior art described above, a need exists for an apparatus that can move rack assemblies in a time efficient manner, without undue manual labor, and without damaging the racks.

### SUMMARY

In one embodiment, the invention provides a rack mover attachable to a rack, the rack mover including a jack for lifting the rack off of the support surface and a jack-mounting assembly. The jack-mounting assembly includes a first member and a second member including hooked projections extending a length through respective openings in the first member. The jack includes a wheel and is coupled to the first member. The hooked projections are configured to engage the rack. A biasing member of the jack-mounting assembly biases the second member in a first direction relative to the first member such that the hooked projections extend a first length through the respective openings. A tightening assembly of the jack-mounting assembly is engaged with the second member and configured to move the second member relative to the first member in a direction substantially opposite the first direction to reduce the length of extension of the hooked projections through the respective openings to a second length that is less than the first length.

In another embodiment, the invention provides a rack mover attachable to a rack for lifting and rolling the rack from one location to another. The rack mover includes a jack assembly and a jack-mounting assembly. The jack includes a body, a rod extensible from and retractable into the body by a jacking mechanism, and a wheel coupled to the rod. The jack-mounting assembly includes a first member having the jack assembly supported adjacent a first side thereof. The first member has a second side configured to face the rack when attached thereto. The jack-mounting assembly further includes a plurality of hooked projections extending through respective openings in the first member. The plurality of hooked projections are configured to engage the rack, and each of the plurality of hooked projections have a leg positioned adjacent the second side of the first member such that a space is defined between the second side of the first member and each of the respective legs. A tightening assembly of the jack-mounting assembly is coupled to the plurality of hooked projections and configured to move the plurality of hooked projections such that the space defined between the legs of the plurality of hooked projections and the second side of the first member is reduced.

In yet another embodiment, the invention provides a method of moving a rack including a plurality of spaced-apart support legs across a support surface from a first location to a second location. The method includes coupling a plurality of rack movers to the plurality of respective spaced-apart support legs of the rack. The coupling of each of the plurality of rack movers includes: inserting a plurality of hooked projections extending from a first side of each rack mover into a respective support leg of the rack with the hooked projections opened substantially upwardly, clamping the respective support leg of the rack between the plurality of hooked projections and the first side of each rack mover, and operating a jack assembly coupled to a second side of each rack mover to lift the respective support leg of the rack off of the support surface. The rack, whose weight is fully supported by casters that extend from each jack assembly of the respective rack movers, is rolled from the first location to the second location.

### BRIEF DESCRIPTION OF THE DRAWINGS

FIG. 1 is a perspective view of a rack mover assembly including a jack assembly and a jack-mounting assembly.

FIG. 2 is a perspective view of the jack assembly of FIG. 1.

FIG. 3 is a perspective view of the jack-mounting assembly of FIG. 1.

FIG. 4 is a front view of the jack-mounting assembly of FIG. 3.

FIG. 5 is a side view of the jack-mounting assembly of FIG. 3.

FIG. 6 is a rear view of the jack-mounting assembly of FIG. 3.

FIG. 7 is an end view of the jack-mounting assembly of FIG. 3, illustrating a tightening assembly of the jack-mounting assembly in a first orientation ready for installation.

FIG. 8 is an end view of the jack-mounting assembly of FIG. 3, illustrating the tightening assembly of the jack-mounting assembly in a second orientation ready for lifting.

FIG. 9 is a first perspective view of a first channel-shaped member of the jack-mounting assembly of FIG. 3.

FIG. 10 is a second perspective view of the first channel-shaped member of FIG. 9.

FIG. 11 is a first perspective view of a second channel-shaped member of the jack-mounting assembly of FIG. 3.

FIG. 12 is a second perspective view of the second channel-shaped member of FIG. 11.

FIG. 13 is a first exploded assembly view of a biasing assembly of the jack-mounting assembly of FIG. 3.

FIG. 14 is a second exploded assembly view of the biasing assembly of FIG. 13.

FIG. 15 is an exploded assembly view of a portion of the tightening assembly of FIGS. 7 and 8.

FIGS. 16-19 are perspective views illustrating the installation of a rack mover assembly onto a leg of a rack assembly.

FIG. 20 is a perspective view of a bottom portion of a rack mover, illustrating the rear side thereof as it is coupled to the leg of the rack assembly.

FIG. 21 is a perspective view of a top portion of the rack mover of FIG. 20, illustrating the rear side thereof as it is coupled to the leg of the rack assembly.

FIG. 22 illustrates a rack assembly having a plurality of rack mover assemblies coupled to respective legs thereof.

FIG. 23 illustrates the rack assembly of FIG. 22 being moved on the rack mover assemblies from a first location to a second location that is remote from the first location.

FIGS. 24-37 illustrate various different legs of rack assemblies having different aperture arrangements.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

### DETAILED DESCRIPTION

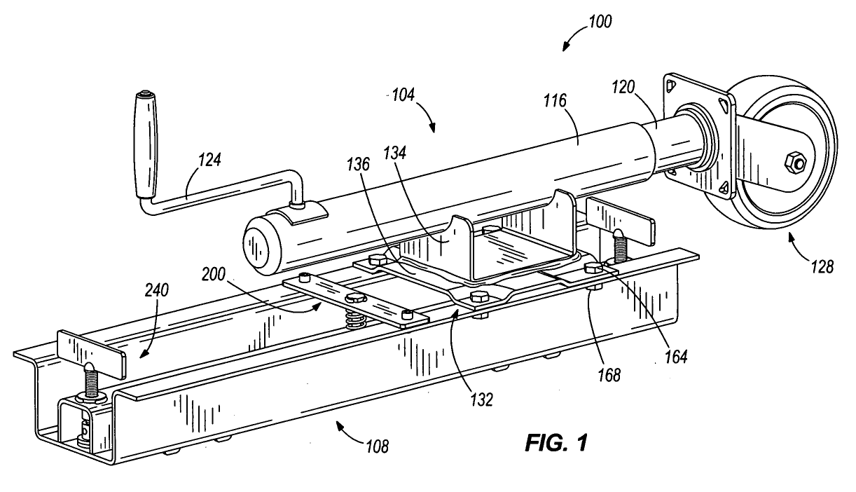

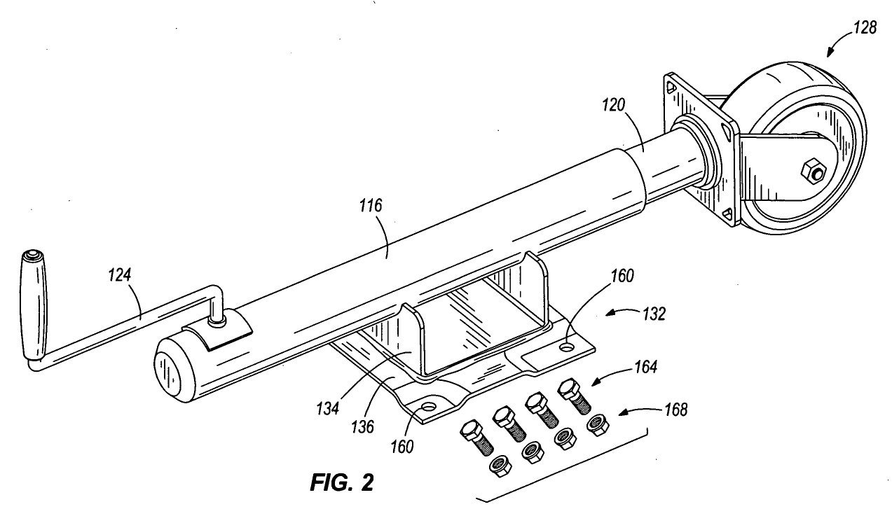

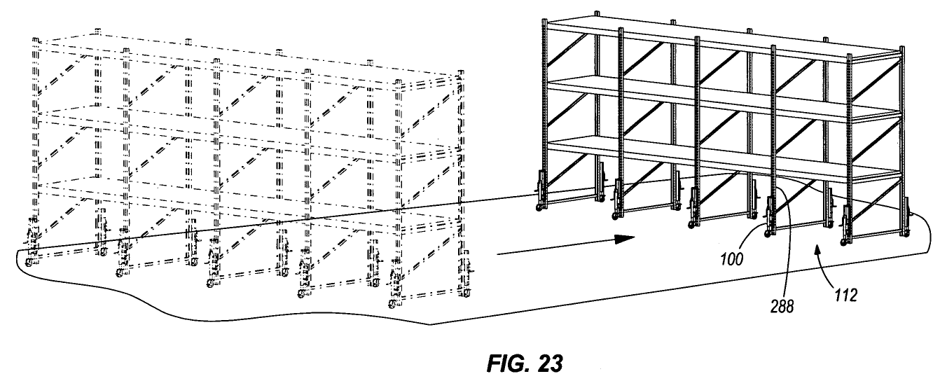

FIG. 1 illustrates one construction of a rack mover assembly 100 including a jack assembly 104 and a jack-mounting assembly 108. The rack mover assembly is removably securable to a rack assembly 112 (FIGS. 23-29) as discussed in further detail below to enable movement of the rack assembly 112. The jack assembly 104 (FIG. 2) includes a cylindrical body 116, which houses a conventional jacking mechanism for selectively extending and retracting an inner rod 120 of the jack assembly 104. A crank 124 extends from the body 116 and is manually rotatable to extend or retract the inner rod 120. A caster 128 or swiveling wheel assembly is coupled to a distal end of the inner rod 120 to define a bottom end of the jack assembly 104 (when the jack assembly 104 assumes a vertical, operational orientation). A bracket 132 of the jack assembly 104 is coupled to the body 116 below the crank 124. The bracket 132 includes a first portion 134 coupled directly to the body 116 and a second portion 136 or mounting plate that is coupled to the jack-mounting assembly 108 as shown in FIG. 1 and discussed in further detail below.

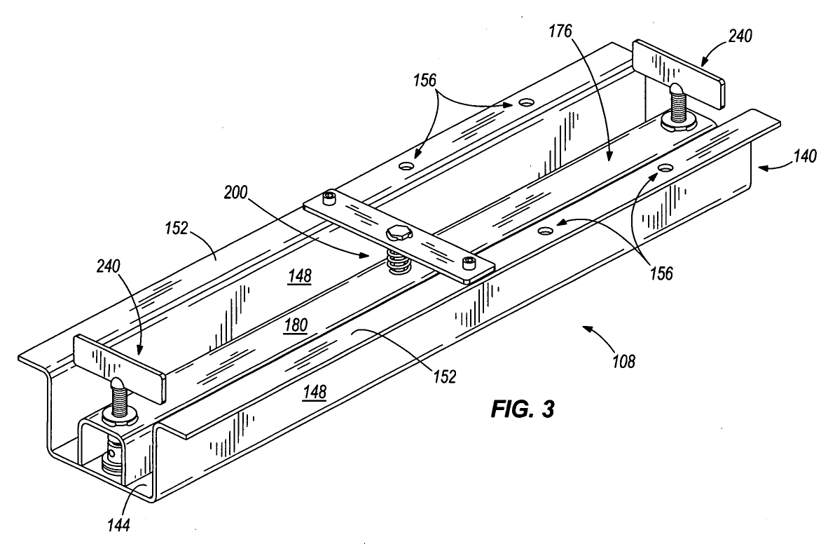

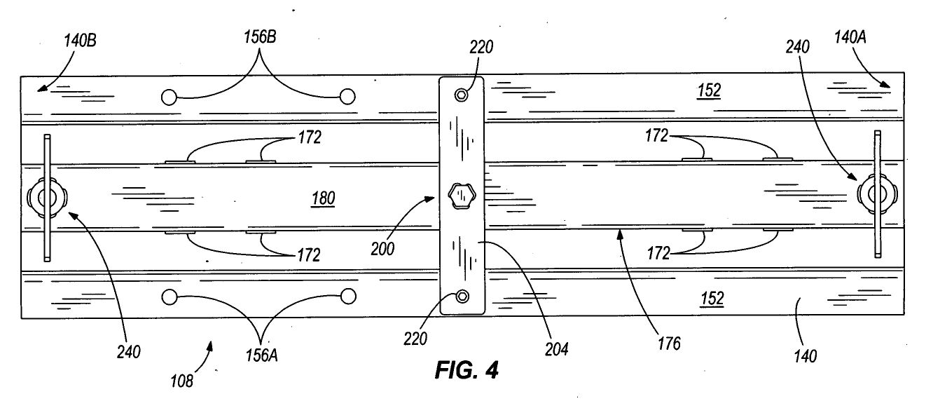

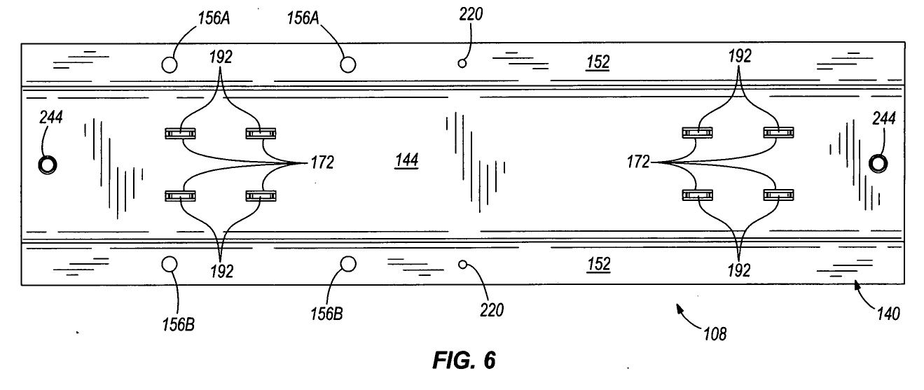

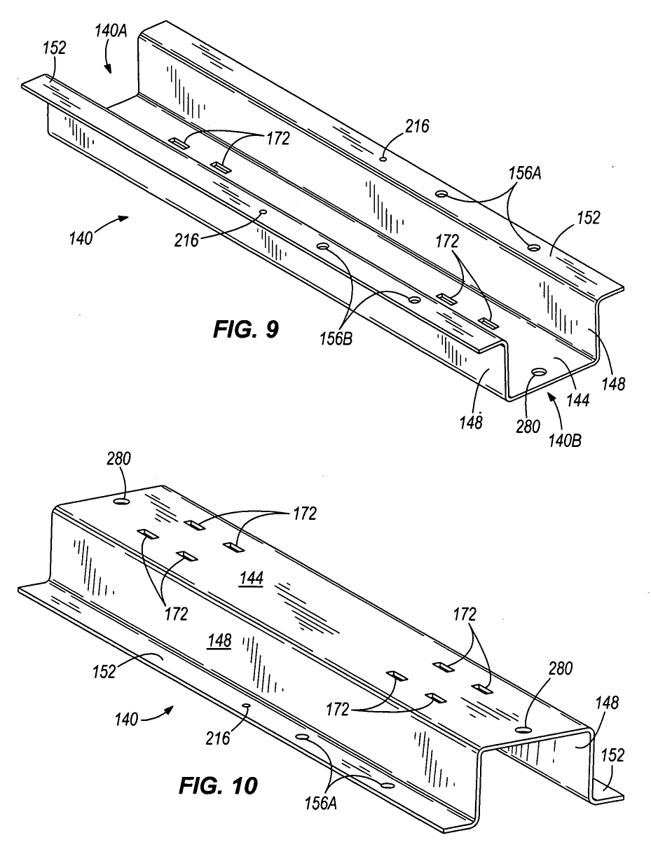

The jack-mounting assembly 108 (FIGS. 3-8) includes a first member 140 (or “first channel member”), which is generally channel-shaped. The first member 140 (FIGS. 9 and 10) includes a base portion 144 and a pair of side portions or sidewalls 148 flanking the base portion 144. Extending from each sidewall 148 is a flange portion 152, which is generally parallel to the base portion 144 and spaced a distance therefrom. Each of the flange portions 152 includes a plurality of apertures 156 for coupling the jack assembly 104 to the first member 140 via the bracket 132. As shown in the figures, one of the flanges 152 includes a first set of spaced-apart apertures 156A, which are generally circular holes. The opposing flange 152 includes a second set of spaced-apart apertures 156B, which are generally oblong, rounded slots. The mounting plate 136 of the bracket 132 includes four apertures 160 (e.g., circular-shaped holes) that can be aligned with the apertures 156 in the flanges 152 of the first member 140. The rounded slots 156B in the second flange 152 allow for brackets manufactured with slightly varying hole spacing dimensions to be coupled to the flanges 152 of the first member 140. The jack 104 is coupled to the first member 140 with threaded fasteners 164 and nuts 168 (FIGS. 1 and 2), but other coupling means, whether permanent, semi-permanent, or quick-release, are optional.

The base 144 of the first channel member 140 defines a series of openings or slots 172 that provide an interface for a second member 176 (or “second channel member”) of the jack-mounting assembly 108. In the illustrated construction, the slots 172 are provided in groups of four. The four slots 172 of each group are spaced apart from each other in a rectangular pattern. The two groups of slots 172 are spaced apart along the length of the first member 140, one group generally adjacent a first end 140A of the first member 140 and the other group generally adjacent a second opposite end 140B of the first member 140.

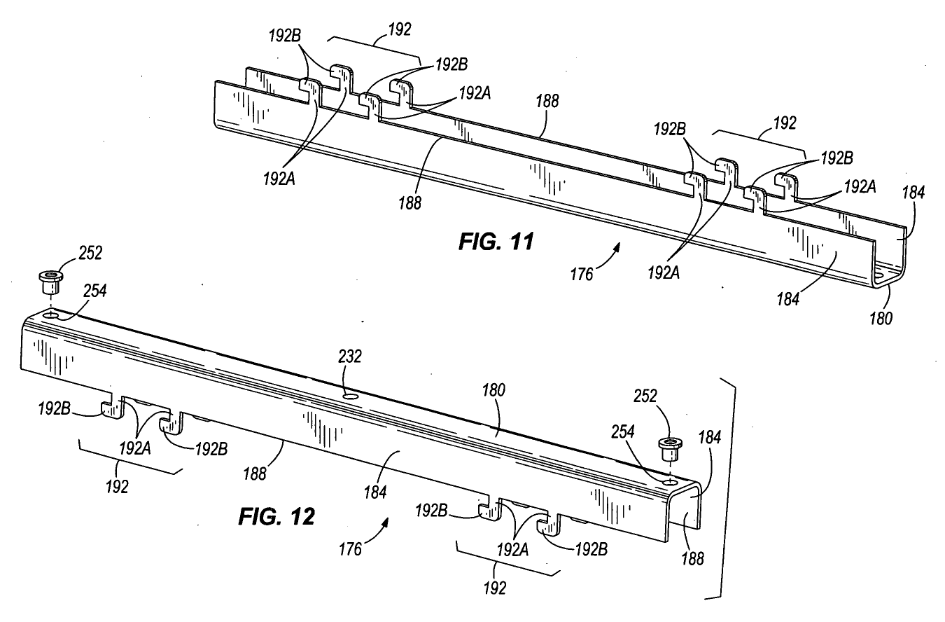

The second member 176 (FIGS. 11 and 12) of the jack-mounting assembly 108 is generally channel-shaped and can be positioned between the sidewalls 148 of the first member 140 and adjacent the base 144 of the first member 140 as best shown in FIGS. 1, 3, 7, and 8. The first and second members 140, 176 of the jack-mounting assembly 108 are similar in overall length in the illustrated construction. The second member 176 includes a base portion 180 and a pair of side portions or sidewalls 184 flanking the base portion 180. The sidewalls 184 extend generally perpendicularly from the base 180 and are generally parallel with each other. Each of the sidewalls 184 of the second member 176 terminates in an edge 188 that extends lengthwise along the second member 176. Extending from the edges 188 are a series of hook-shaped projections 192 (hereinafter “hooks”) arranged in groups having a similar orientation to that of the slots 172 in the base 144 of the first channel member 140. The hooks 192 are generally co-planar with their respective sidewalls 184 of the second member 176. Each of the hooks 192 includes a first leg 192A extending directly from the respective sidewall 184 and a second leg 192B extending from and oriented at an angle (e.g., a 90 degree angle) relative to the first leg 192A. The second legs 192B are therefore spaced a distance from the edges 188 of the sidewalls 184.

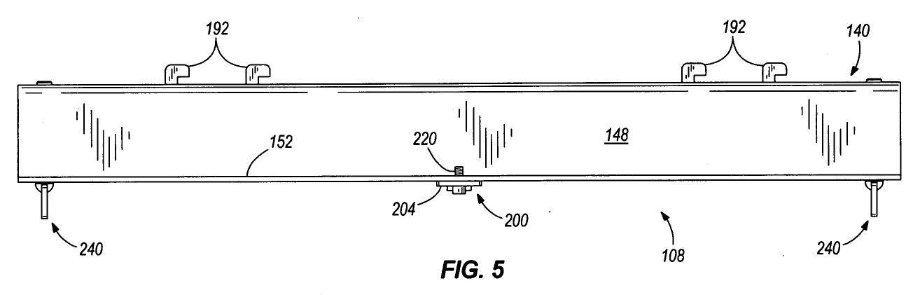

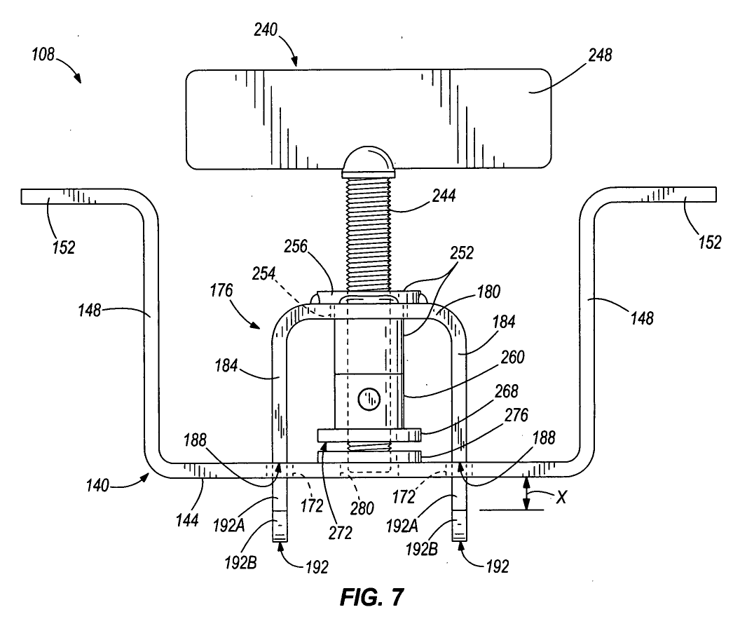

As shown in FIGS. 5-7, the second channel member 176 is positioned with its sidewall edges 188 adjacent the base 144 of the first channel member 140 so that the hooks 192 of the second channel member 176 extend substantially through the slots 172 in the base 144 of the first channel member 140. In this position, a gap X (see FIG. 7) exists between the base 144 of the first channel member 140 and the second legs 192B of each of the hooks 192 that have been inserted through the slots 172. The gap X enables attachment of the rack mover assembly 100 to a rack assembly 112 as described in further detail below.

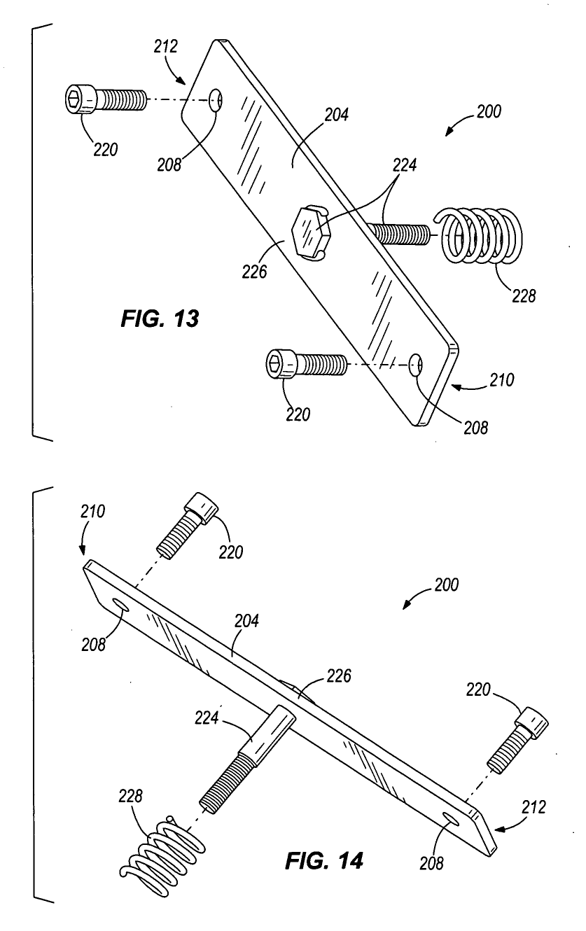

A biasing assembly 200 (FIGS. 13 and 14) of the jack-mounting assembly 108 provides a biasing force that urges the second channel member 176 (particularly the sidewall edges 188 of the second channel member 176) into engagement with the base 144 of the first channel member 140. The biasing assembly 200 includes a transverse member 204 that spans across the two flanges 152 of the first channel member 140. The transverse member 204 includes an aperture 208 adjacent both a first end 210 and a second end 212. The apertures 208 in the transverse member 204 can be aligned with corresponding apertures 216 in the first and second flanges 152 of the first channel member 140 and coupled thereto. In the illustrated construction, the transverse member 204 is coupled to the first channel member 140 with a pair of threaded fasteners 220. Other means for coupling the transverse member 204 or the biasing assembly 200 in general to the first channel member 140, whether permanent, semi-permanent, or quick-release, may also or alternatively be used.

A protruding member 224 projects from a central portion of the transverse member 204. In one construction, the protruding member 224 is a bolt that extends through a central portion 226 of the transverse member 204. The bolt 224 may be welded to the transverse member 204 so that the transverse member 204 and the bolt 224 are inseparable. The protruding member 224, which may be unitary with or separate from the transverse member 204, extends at least partially through the second channel member 176 as best shown in FIGS. 1, 3, and 4. In the illustrated construction, the protruding member 224 extends through a biasing member 228 positioned between the transverse member 204 and the second channel member 176 and through a clearance opening 232 in the base 180 of the second channel member 176. When the transverse member 204 is coupled to the first channel member 140, the biasing member 228 is compressed and exerts a biasing force upon the second channel member 176 that urges the second channel member 176 against the base 144 of the first member 140 to ensure that the hooks 192 extend fully through the slots 172 in the base 144 of the first channel member 140 to maintain the maximum gap X between the respective second legs 192B of the hooks 192 and the base 144 of the first channel member 140. In the illustrated construction, the biasing member 228 is a coil spring.

With the hooks 192 of the second channel member 176 extending through the slots 172 in the base 144 of the first channel member 140, and with the biasing assembly 200 in position to urge the second channel member 176 into the first channel member 176, the rack mover assembly 100 is in condition for attachment to a rack assembly 112. Additional components of the jack-mounting assembly 108 are described prior to the description of attachment and use of the rack mover assembly 100 with a rack assembly 112.

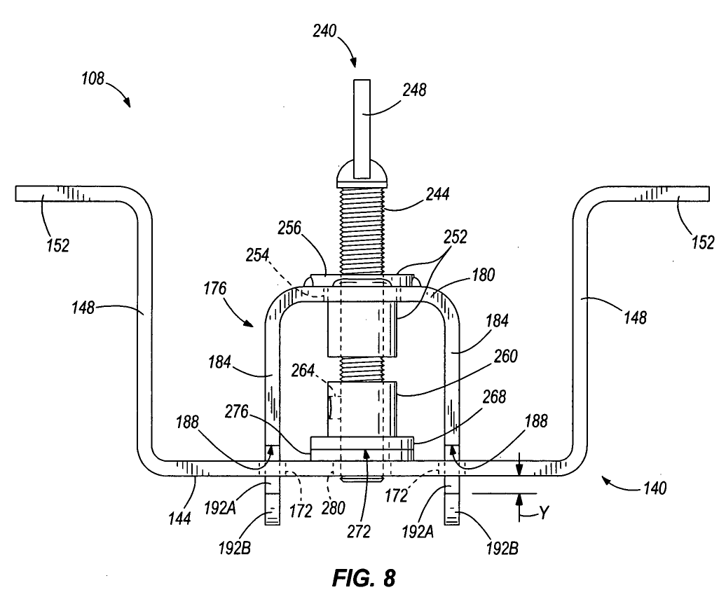

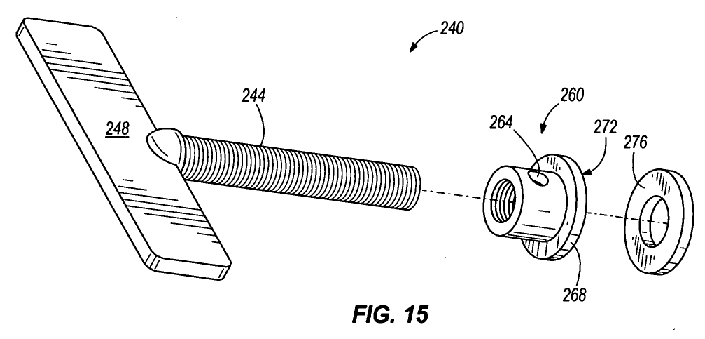

As best shown in FIGS. 7, 8, and 15, tightening assemblies 240 are provided on both ends of the biasing assembly 200. The biasing assembly 200 is not shown in FIGS. 7 and 8 for clarity in showing the parts of one of the tightening assemblies 240. In the illustrated construction the tightening assemblies 240 are provided adjacent each of the lengthwise ends of the jack-mounting assembly 108. The purpose of the tightening assemblies 240 is to secure the jack-mounting assembly 108 (and thereby the jack assembly 104 and the rack mover assembly 100 as a whole) to the rack assembly 112. Each tightening assembly 240 includes the components shown in FIG. 15. A threaded member 244 is formed with or joined with a handle 248. In the illustrated construction, a large, flat handle 248 is coupled to the threaded member 244 (e.g., by welding) to provide for convenient manual operation of the tightening assembly 240. Other types and/or sizes of handles may be substituted, and alternatively, the threaded member 244 may be simply provided with a standardized head that is engageable with a wrench, socket, screwdriver, etc.

As shown in FIGS. 7 and 8, a first nut 252 is fixed to the second channel member 176 and is internally threaded to engage the threaded member 244 of the tightening assembly 240. The first nut 252 is positioned in an opening 254 in the base 180 of the second channel member 176. In some constructions, the first nut 252 may be a weld nut as illustrated, having a flange 256 that is welded to the base 180 of the second channel member 176. In the illustrated construction, the flange 256 of the weld nut 252 is fixed to the base 180 of the second channel member 176 on the exposed side thereof, although it is realized that alternate configurations are optional. Alternately, the second channel member 176 may be provided with a threaded hole to receive and engage the threaded member 244. A second nut 260, which may be substantially similar to the first nut 252, is fixed to the end of the threaded member 244 opposite the handle 248 as described in further detail below.

The second nut 260, may be threaded onto the threaded member 244 and subsequently welded to the threaded member 244 (e.g., by plug welding). The second nut 260 may be formed with a transverse aperture 264 therethrough to define a location for the plug weld. When welded together, the second nut 260 rotates synchronously with the threaded member 244 (and the handle 248). Furthermore, the flange 268 on the second nut 260 is positioned towards the end of the threaded member 244 that is opposite the handle 248 so as to provide a thrust face 272 as described in further detail below.

From the handle 248, the threaded member 244 extends through the first nut 252 (which is fixed to the second channel member 176), the second nut 260, a thrust member 276, and at least partially through an aperture 280 in the base 144 of the first channel member 140. When the threaded member 244 is fully backed out as shown in FIG. 7 (so that the first and second nuts 252, 260 contact each other), there is a space between the thrust face 272 of the second nut 260 and the base 144 of the first channel member 140 that is larger than a thickness of the thrust member 276. The thrust member 276 is retained in position by the threaded member 244, which extends at least partially into the base 144 of the first channel member 140 even when fully backed out as shown in FIG. 8.

As described in further detail below, the threaded member 244 may be rotated to an engaged position (FIG. 8) in which the gap between the base 144 of the first channel member 140 and the second legs 192B of the hooks 192 is decreased to a value Y, which is substantially less than the maximum value X. When the threaded member 244 is rotated towards the engaged position from the fully backed out position, the second nut 260 moves axially away from the first nut 252 and axially towards the thrust member 276 and the base 144 of the first channel member 140. Once the thrust face 272 of the second nut 260 engages the thrust member 276 and the threaded member 244 is still being rotated, an increasing thrust load is exerted on the thrust member 276. After the thrust member 276 is engaged by the second nut 260, further rotating of the threaded member 244 overcomes the biasing member 228 of the biasing assembly 200 in order to move the second channel member 176 relative to the first channel member 140 (such that the respective bases 144, 180 of the first and second channel members 140, 176 are increasingly spaced apart). In some constructions, the thrust member 276 is a thrust washer constructed of a material (e.g., bronze) having a relatively low friction coefficient with the second nut 260 and the base 144 of the first channel member 140. In some constructions, the thrust member 272 is a roller bearing including multiple races and either balls or cylindrical rollers. Furthermore, the thrust member 276 may be an integral part of either the base 144 of the first channel member 140 or the second nut 260, and in such constructions, the second nut 260 directly engages the first channel member 140.

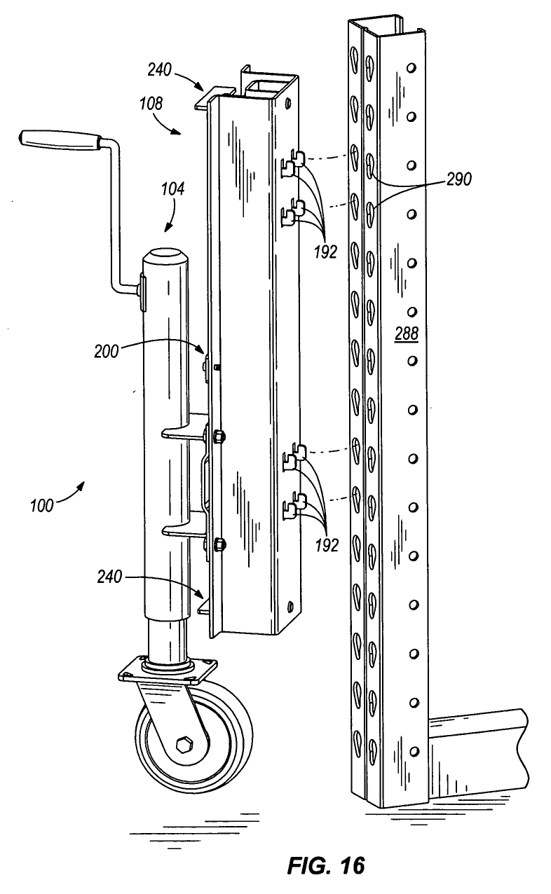

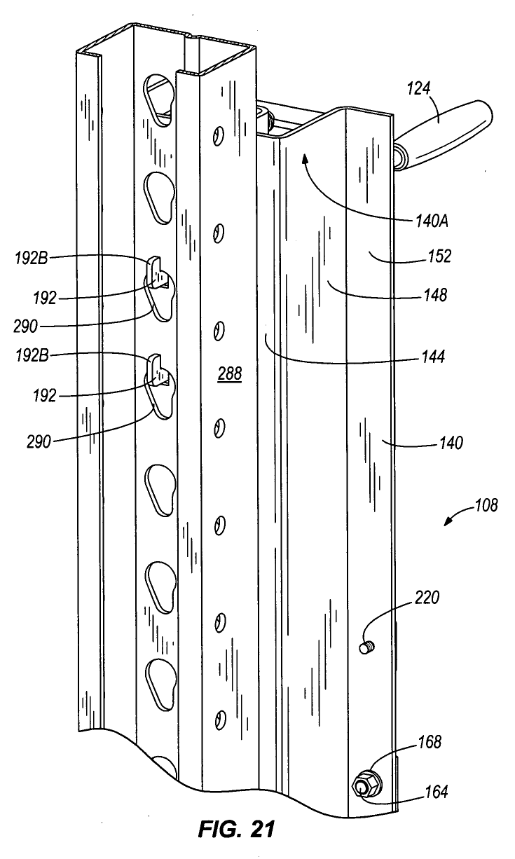

The operation of the rack mover assembly 100 is described primarily with reference to FIGS. 16-23. With the jack-mounting assembly 108 in the installation condition (FIG. 7—threaded members 244 of the tightening assemblies 240 fully backed out), the rack mover assembly 100 is positioned adjacent a portion of a rack assembly 112. As shown in FIG. 16, the rack mover assembly 100 is positioned adjacent a leg 288 or upright of the rack assembly 112. The leg 288 of the rack assembly 112 includes a plurality of apertures 290 arranged in side-by-side pairs, and the pairs are spaced apart vertically. The hooks 192 of the second channel member 176 are sized and shaped to fit into a variety of different types of rack apertures as discussed in further detail below. The hooks 192 of the second channel member 176 are aligned with the apertures 290 in the leg 288 of the rack assembly 112 as shown in FIG. 16. The second legs 192B of the hooks 192 extend upwardly and the caster 128 of the jack assembly 104 is on or slightly above the floor.

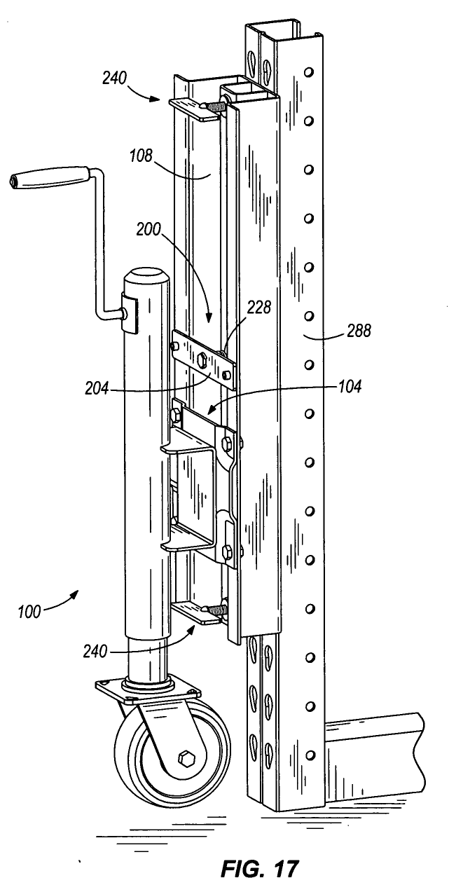

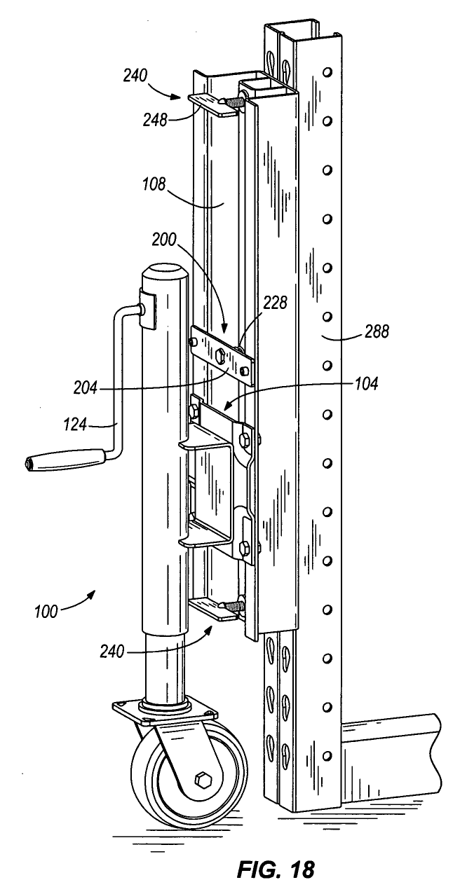

As shown in FIG. 17, the rack mover assembly 100 is moved into engagement with the leg 288 of the rack assembly 112 such that the hooks 192 extend through the apertures 290 in the leg 288, and the base 144 of the first channel member 140 lies flush against the leg 288. The jack assembly 104 is then operated a small amount by the crank 124 so that the caster 128 contacts the floor (FIG. 18) and the jack-mounting assembly 108 is lifted slightly so that the first legs 192A of the hooks 192 make contact with the leg 288 of the rack assembly 112 and so that further operation of the jack 104 would begin to lift the rack assembly 112. This ensures that the hooks 192 are as far up into the apertures 290 in the legs 288 as possible while the maximum gap X exists between the second legs 192B of the hooks 192 and the base 144 of the first channel member 140. At this point during installation, there is not a significant lifting force being applied to the rack assembly 112. Before a lifting force is applied, the tightening assemblies 240 are operated to laterally pinch or clamp the leg 288 between the hooks 192 and the first channel member 140 (and preferably, additional rack moving assemblies 100 are coupled to the rack assembly 112).

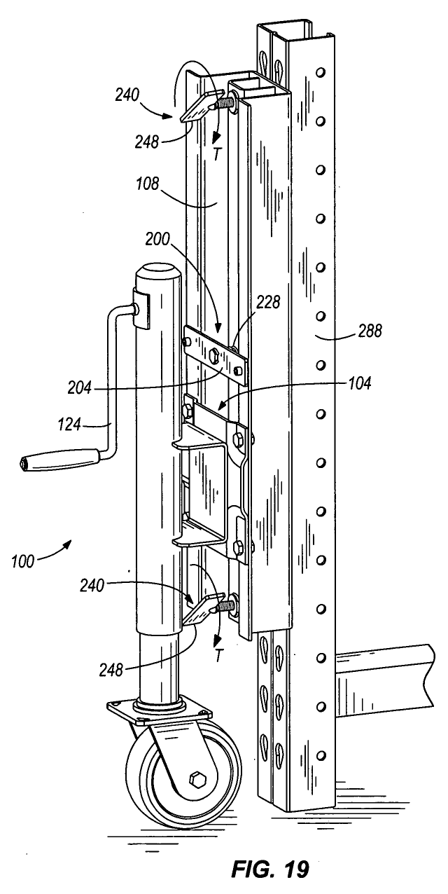

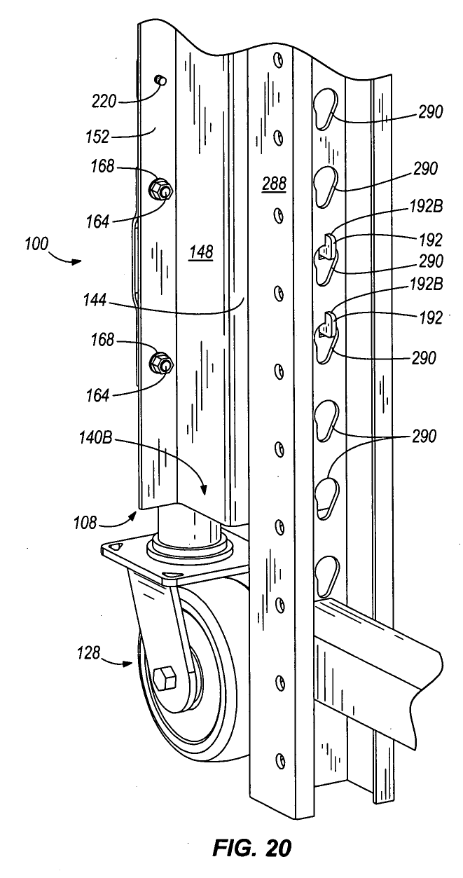

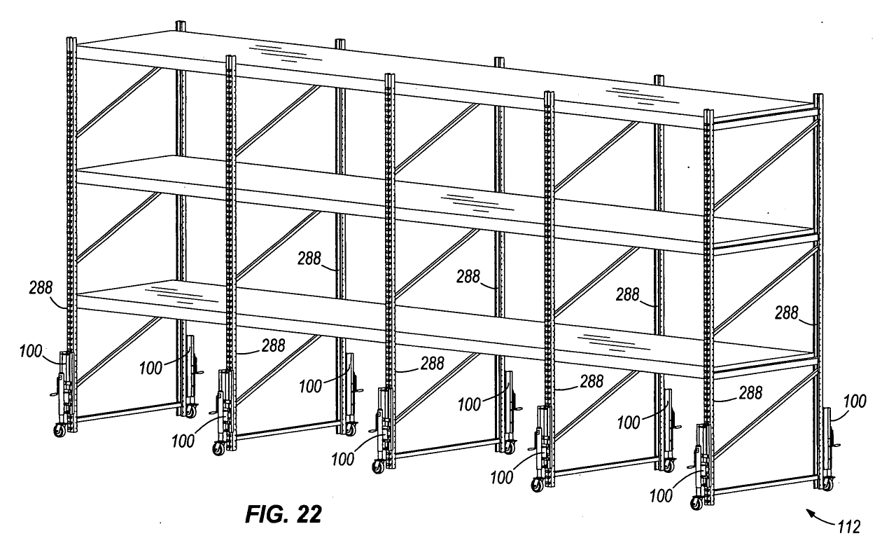

As shown in FIG. 19 by the two arrows T, the upper and lower tightening assemblies 240 are operated by the handles 248 to rotate the threaded members 244 and drive or “retract” the second channel member 176 outwardly away from the base 144 of the first channel member 140. As described above and illustrated in FIGS. 20-22, retraction of the second channel member 176 causes the second legs 192B of the hooks 192 to move into engagement with the leg 288. Once in contact with both the base 144 of the first channel member 140 and the second legs 192B of the hooks 192, the leg 288 receives an increasing pinching or lateral clamping force as the threaded members 244 are rotated further. Thus, when the threaded members 244 are appropriately rotated, the leg 288 is securely clamped between the second legs 192B of hooks 192 and the base 144 of the first channel member 140. At this point during installation, the jack assembly 104 is securely fastened to the leg 288 of the rack assembly 112 by way of the jack-mounting assembly 108, and the caster 128 of the jack assembly 104 is in contact with the floor, preferably supporting only a fraction of the weight of the rack assembly 112 (and contents thereof, if any). As shown in FIGS. 22 and 23, there may be one rack mover assembly 100 provided at each leg 288 of the rack assembly 112. In some instances, there may be a rack mover assembly 100 (including a jack assembly 104) provided at only a selected portion or fraction of the rack assembly's legs 288.

FIG. 23 illustrates the rack assembly 112 being transported from a first location to a second location, which is remote from the first location. When the desired number of rack moving assemblies 100 are coupled to the rack assembly 112, the cranks 124 of the jack assemblies 104 are operated to lift the rack assembly 112 (e.g., the legs 288 of the rack assembly 112) off the ground. When the rack assembly 112 is lifted off the ground, the total weight of the rack assembly 112 (and any contents thereof) is supported by the casters 128 of the jack assemblies 104. The casters 128 may include ball bearings, thus enabling the rack assembly 112 to be moved in virtually any lateral direction across the floor with a relatively small pushing or pulling force by one or more workers on the floor. Alternately, one or more powered machines, such as a forklift, may be used alone or in combination with workers to move the rack assembly 112.

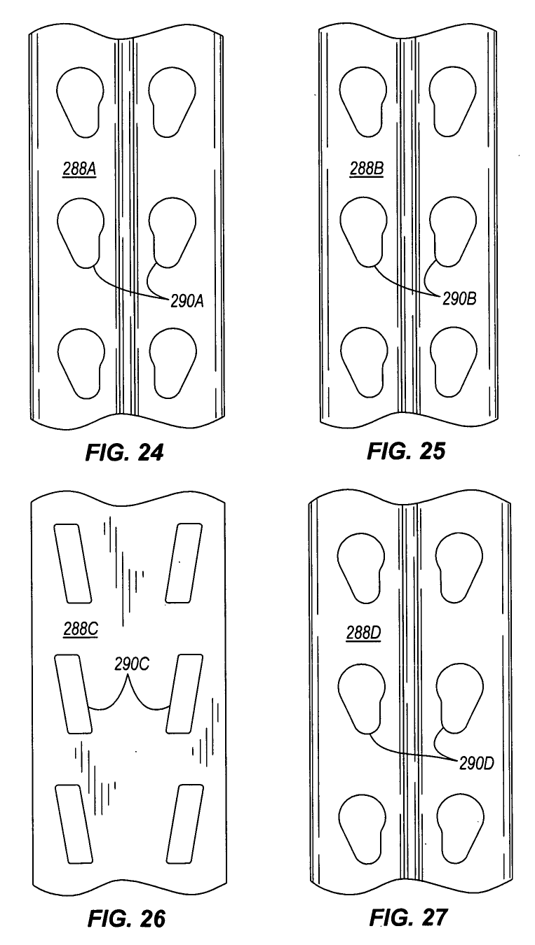

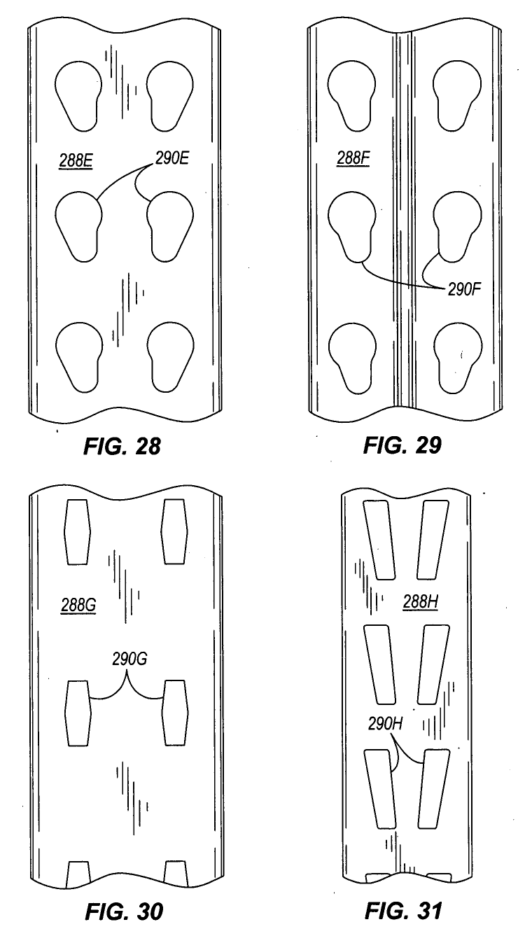

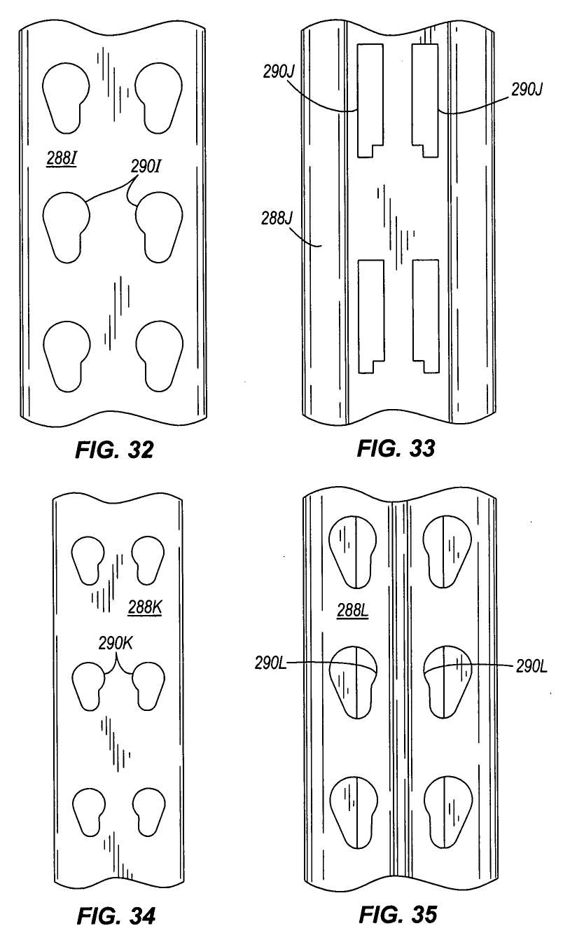

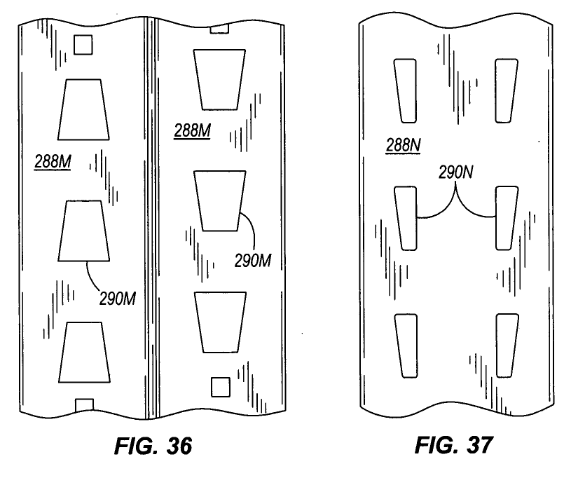

FIGS. 24-37 illustrate various configurations of apertures 290A-290N that may be found on the legs 288A-288N of rack assemblies 112. As shown in the figures, some of the apertures 290 are generally tear drop shaped, while others are substantially more rectangular (as opposed to rounded) and in some cases are slanted into a chevron shape. The arrangement of hooks 192 extending from the second channel member 176 is selected to interface with a variety of different leg aperture arrangements (i.e., differently shaped apertures 290, differently sized apertures 290, differently spaced apertures 290, etc.) so that the rack mover assembly 100 is somewhat “universal” and may be used with many different rack assemblies 112.

Thus, the invention provides, among other things, a rack mover assembly 100 that is quickly attachable to a leg 288 of a rack assembly 112 and operable to lift the leg 288 off the ground to facilitate rolling of the rack assembly 112 on a wheel 128 of the rack mover assembly 100. In some configurations, the rack mover assembly 100 is attachable to and detachable from the rack assembly 112 simply and without the use of any tools or separable hardware. A plurality of fully independent rack moving assemblies 100 can be coupled to a multi-leg rack assembly 112 to make the rack assembly 112 mobile.

What is claimed is:

1. A rack mover attachable to a rack, the rack mover comprising:
a jack for lifting the rack off of the support surface including a wheel; and
a jack-mounting assembly including
a first member, the jack being coupled to the first member,
a second member including hooked projections extending a length through respective openings in the first member, the hooked projections being configured to engage the rack,
a biasing member biasing the second member in a first direction relative to the first member such that the hooked projections extend a first length through the respective openings, and
a tightening assembly engaged with the second member and configured to move the second member relative to the first member in a direction substantially opposite the first direction to reduce the length of extension of the hooked projections through the respective openings to a second length that is less than the first length.

2. The rack mover of claim 1, wherein the first member includes a base, a first flange spaced from the base, and a second flange spaced from the base.

3. The rack mover of claim 2, wherein the jack includes a bracket that is coupled to the first and second flanges of the first member, and the openings in the first member are formed in the base.

4. The rack mover of claim 1, wherein the tightening assembly includes a nut fixed to the second member and a threaded member rotatably engaged with the nut.

5. The rack mover of claim 4, wherein a thrust face carried by the threaded member is configured to exert a thrust force upon the first member such that rotation of the threaded member relative to the first and second members moves the second member relative to the first member in a direction substantially opposite the first direction against the biasing member.

6. The rack mover of claim 1, wherein the tightening assembly is a first tightening assembly positioned adjacent a first lengthwise end of the jack and the jack-mounting assembly further includes a second tightening assembly positioned adjacent a second opposite lengthwise end of the jack.

7. The rack mover of claim 1, wherein a spacing between at least two adjacent ones of the hooked projections is standardized according to a predetermined spacing between openings in the rack into which the hooked projections are configured to enter.

8. A rack mover attachable to a rack for lifting and rolling the rack from one location to another, the rack mover comprising:
a jack assembly including a body, a rod extensible from and retractable into the body by a jacking mechanism, and a wheel coupled to the rod; and
a jack-mounting assembly including
a first member having the jack assembly supported adjacent a first side thereof, the first member having a second side configured to face the rack when attached thereto,
a plurality of hooked projections extending through respective openings in the first member, the plurality of hooked projections being configured to engage the rack, each of the plurality of hooked projections having a leg positioned adjacent the second side of the first member such that a space is defined between the second side of the first member and each of the respective legs, and
a tightening assembly coupled to the plurality of hooked projections and configured to move the plurality of hooked projections such that the space defined between the legs of the plurality of hooked projections and the second side of the first member is reduced.

9. The rack mover of claim 8, wherein the first member includes a base, a first flange spaced from the base, and a second flange spaced from the base, and wherein the openings in the first member are formed in the base.

10. The rack mover of claim 9, wherein the jack assembly further includes a bracket coupled to the body, the bracket of the jack assembly is coupled to the first and second flanges of the first member.

11. The rack mover of claim 8, wherein the plurality of hooked projections are part of a second member that is adjustably coupled to the first side of the first member.

12. The rack mover of claim 11, wherein the jack-mounting assembly further includes a biasing member urging the second member in a first direction.

13. The rack mover of claim 12, wherein the tightening assembly includes a threaded member rotatably engaged with the second member.

14. The rack mover of claim 13, wherein a thrust face carried by the threaded member is configured to exert a thrust force upon the first member such that rotation of the threaded member relative to the second member moves the second member in a direction substantially opposite the first direction against the biasing member.

15. The rack mover of claim 12, wherein the tightening assembly is operable in conjunction with the biasing member in two directions to selectively adjust the space defined between the legs of the plurality of hooked projections and the second side of the first member.

16. The rack mover of claim 8, wherein the tightening assembly is a first tightening assembly positioned adjacent a first lengthwise end of the jack-mounting assembly, the jack-mounting assembly further including a second tightening assembly positioned adjacent a second opposite lengthwise end of the jack-mounting assembly.

17. The rack mover of claim 8, wherein a spacing between individual ones of the plurality of hooked projections is standardized according to a predetermined spacing between openings in the rack into which the plurality of hooked projections are configured to enter.

18. A method of moving a rack including a plurality of spaced-apart support legs across a support surface from a first location to a second location, the method comprising:
coupling a plurality of rack movers to the plurality of respective spaced-apart support legs of the rack, the coupling of each of the plurality of rack movers including
inserting a plurality of hooked projections extending from a first side of each rack mover into a respective support leg of the rack with the hooked projections opened substantially upwardly;
clamping the respective support leg of the rack between the plurality of hooked projections and the first side of each rack mover, and
operating a jack assembly coupled to a second side of each rack mover to lift the respective support leg of the rack off of the support surface; and
rolling the rack, whose weight is fully supported by casters that extend from each jack assembly of the respective rack movers, from the first location to the second location.

19. The method of claim 18, wherein clamping the respective support leg of the rack between the plurality of hooked projections and the first side of the rack mover includes turning a threaded member of a tightening assembly.

20. The method of claim 19, wherein clamping the respective support leg of the rack between the plurality of hooked projections and the first side of the rack mover includes moving the plurality of hooked projections toward the first side of the rack mover against a biasing member.
